(19) United States
(12) Patent Application Publication
(10) Pub. No.: US 2026/0367898 A1
(43) Pub. Date: Nov. 19, 2026

(54) ELECTRONIC APPARATUS

(71) Applicant: KYOCERA Document Solutions Inc., Osaka (JP)

(72) Inventors: Daichi Iida, Osaka (JP); Masato Shiose, Osaka (JP); Koji Kuroda, Osaka (JP)

(21) Appl. No.: 19/205,867

(22) Filed: May 12, 2025

(30) Foreign Application Priority Data
May 20, 2024 (JP) 2024-082129

(51) Int. Cl. G06F 8/65

(52) U.S. Cl. CPC G06F 8/65

(57) ABSTRACT

An electronic apparatus includes a processor, a bootcode, a first firmware code, a backup code of the first firmware code, a second firmware code, a restoration code of the second firmware code, and a communication device. Further, the processor (a) executes the bootcode and determines whether the first firmware code is falsified or not, (b) if it is determined that the first firmware code is not falsified, executes the first firmware code and determines whether the second firmware code is falsified or not, (c) if it is determined that the first firmware code is falsified, restores the first firmware code with the backup code, and (d) if it is determined that the second firmware code is falsified, executes the restoration code and thereby accesses an external server, downloads a genuine firmware code from the external server, and restores the second firmware code with the downloaded genuine firmware code.

### CROSS-REFERENCE TO RELATED APPLICATIONS

This application relates to and claims priority rights from Japanese Patent Application No. 2024-082129, filed on May 20, 2024, the entire disclosures of which are hereby incorporated by reference herein.

### BACKGROUND

### 1. Field of the Present Disclosure

The present disclosure relates to an electronic apparatus.

### 2. Description of the Related Art

In an information processing apparatus, when the information processing apparatus starts, (a) a BIOS is executed, (b) if the BIOS does not detect falsification of a loader, the loader is executed, (c) if the loader does not detect falsification of a kernel, the kernel is executed, (d) if the kernel does not detect falsification of a native program, the native program is executed, and (e) if the falsification is detected, all of a genuine loader, a genuine kernel, and a native program are transmitted and received from an external storage device, and restoration is performed with them.

However, in the aforementioned information processing apparatus, when the falsification is detected, all of the loader, the kernel and the native program are always transmitted and received, and therefore, for restoration due to the falsification detection, a large memory area must be allocated to store program codes of them, and a storage device that has a relatively large storage capacity is required, and consequently, it results in a high cost of the apparatus.

### SUMMARY

An electronic apparatus according to an aspect of the present disclosure includes a processor, a bootcode, a first firmware code, a backup code of the first firmware code, a second firmware code, a restoration code of the second firmware code, and a communication device. Further, the processor (a) executes the bootcode and determines whether the first firmware code is falsified or not, (b) if it is determined that the first firmware code is not falsified, executes the first firmware code and determines whether the second firmware code is falsified or not, (c) if it is determined that the first firmware code is falsified, restores the first firmware code with the backup code, and (d) if it is determined that the second firmware code is falsified, executes the restoration code and thereby accesses an external server using the communication device, downloads a genuine firmware code from the external server, and restores the second firmware code with the downloaded genuine firmware code.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of a network system including an electronic apparatus according to an embodiment of the present disclosure;

FIG. 2 shows a block diagram that indicates a configuration of the electronic apparatus according to an embodiment of the present disclosure; and

FIG. 3 shows a flowchart that explains a behavior of the electronic apparatus shown in FIG. 2.

### DETAILED DESCRIPTION

Hereinafter, an embodiment according to an aspect of the present disclosure will be explained with reference to drawings.

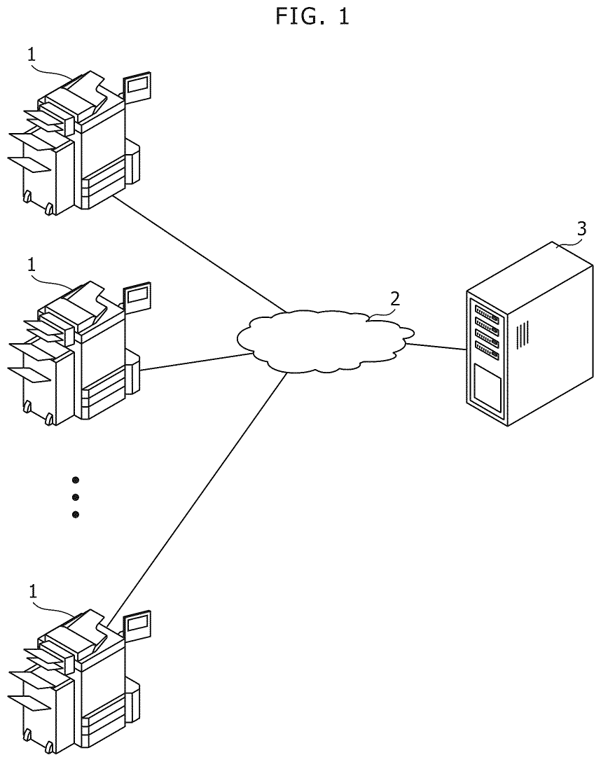

FIG. 1 shows a block diagram that indicates a configuration of a network system including an electronic apparatus according to an embodiment of the present disclosure. As shown in FIG. 1, an electronic apparatus 1 is connected to a computer network 2 and capable of data communication with an external server 3 through the computer network 2. The electronic apparatus 1 is a multi function peripheral or the like, the computer network 2 is a LAN (Local Area Network), an intra net, Internet or the like, and the external server 3 is a server that provides a genuine firmware code to the electronic apparatus 1.

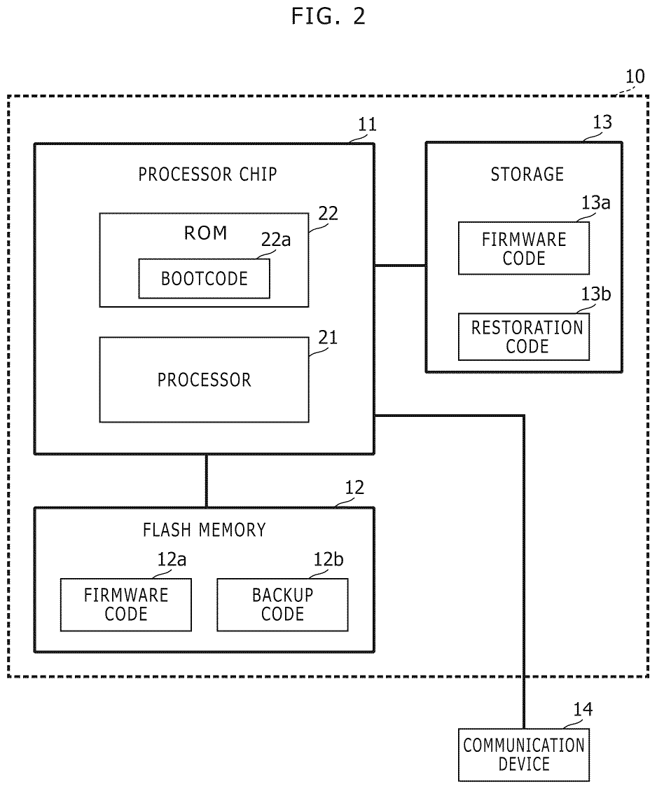

FIG. 2 shows a block diagram that indicates a configuration of the electronic apparatus 1 according to an embodiment of the present disclosure. As shown in FIG. 2, the electronic apparatus 1 includes a circuit board 10, a processor chip 11 such as ASIC (Application Specified Integrated Circuit), a flash memory 12, a storage 13 such as hard disk drive or SSD (Solid State Drive), and a communication device 14.

Here, the processor chip 11, the flash memory 12 and the storage 13 are installed on the circuit board 10. The storage 13 may be installed individually from the circuit board 10.

The processor chip 11 includes a processor 21 such as CPU (Central Processing Unit), and a ROM (Read Only Memory) 22.

The processor 21 reads a program stored in the flash memory 12, the storage 13 or the like and executes the program, and thereby performs sorts of processes.

In the ROM 22, a bootcode 22a is stored; in the flash memory 12, a firmware code 12a and a backup code 12b of the firmware code 12a are stored; and in the storage 13, a firmware code 13a and a restoration code 13b are stored. The backup code 12b may be a code identical to the firmware code 12a before falsification or may be a different code. The restoration code 13b is a code different from the firmware code 13a and is smaller than the firmware code 13a.

The communication device 14 such as network interface performs data communication with the external server 3 through the computer network 2.

Further, when this electronic apparatus is powered on, the processor 21 (a) executes the bootcode 22a and thereby determines whether the firmware code 12a is falsified or not, (b) if it is determined that firmware code 12a is not falsified, executes the firmware code 12a and thereby determines whether the firmware code 13a is falsified or not. The falsification detection is performed in accordance with an existing method.

In this process, if it is determined that the firmware code 12a is falsified, the processor 21 restores the firmware code 12a with the backup code 12b. For example, the firmware code 12a is rewritten with the backup code 12b.

On the other hand, if it is determined that the firmware code 13a is falsified, the processor 21 executes the restoration code 13b and thereby accesses the external server 3 using the communication device 14, downloads a genuine firmware code, and restores the firmware code 13a with the downloaded genuine firmware code. Thus, the firmware code 13a is rewritten with the genuine firmware code.

Further, if the firmware code 13a is restored, the processor 21 reboots this electronic apparatus 1 after the restoration. Contrarily, after the firmware code 12a is restored, if it is determined that the firmware code 13a is not falsified, the processor 21 does not reboot this electronic apparatus 1 and performs a starting process based on the firmware code 13a.

In other words, the firmware code 13a is a firmware code that requires reboot of this electronic apparatus 1 when the restoration (replacement) is performed, and the firmware code 12a is a firmware code that does not require reboot of this electronic apparatus 1 when the restoration (replacement) is performed.

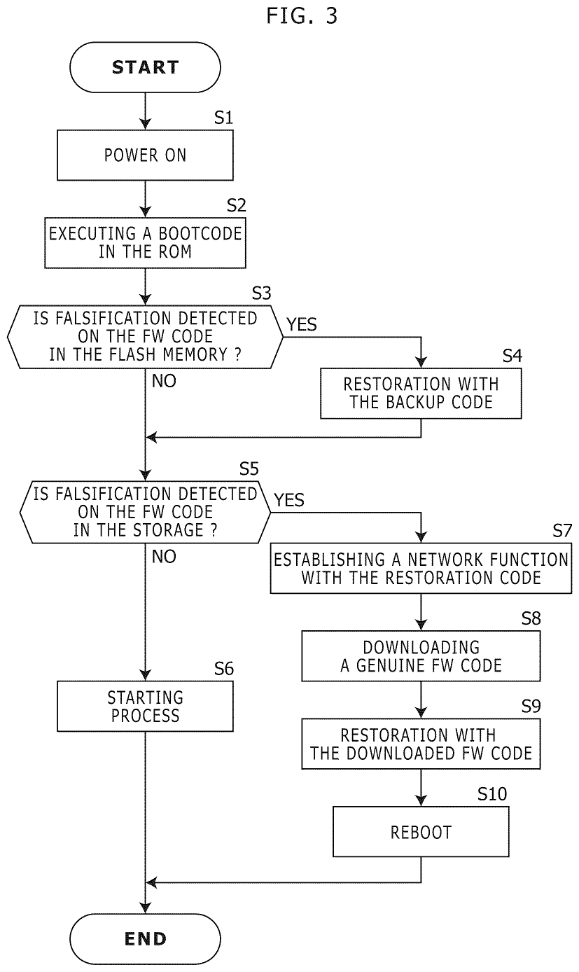

The following part explains a behavior of the aforementioned apparatus. FIG. 3 shows a flowchart that explains a behavior of the electronic apparatus 1 shown in FIG. 2.

When this electronic apparatus 1 is powered on (in Step S1), the processor 21 reads and executes the bootcode 22a (in Step S2), and determines whether the firmware code 12a in the flash memory 12 is falsified or not (in Step S3).

If it is determined that the firmware code 12a is falsified, then the processor 21 reads and executes the backup code 12b (in Step S4).

Subsequently, the processor 21 determines whether the firmware code 13a in the storage 13 is falsified or not in accordance with the firmware code 12a or the backup code 12b (in Step S5).

If it is determined that the firmware code 13a in the storage 13 is not falsified, the processor 21 reads and executes the firmware code 13a in the storage 13, and thereby performs a starting process (in Step S6).

Contrarily, if it is determined that the firmware code 13a in the storage 13 is falsified, the processor 21 reads and executes the restoration code 13b and in accordance with the restoration code 13b, controls the communication device 14 and thereby accesses the external server 3 (in Step S7), downloads a genuine firmware code from the external server 3 (in Step S8), and restores the firmware code 13a with the downloaded genuine firmware code (in Step S9). Afterward, the processor 21 performs reboot of this electronic apparatus 1 in accordance with the restoration code 13b (in Step S10). After the reboot, a process in Step S2 and its subsequent processes are performed.

As mentioned, the electronic apparatus 1 according to this embodiment includes the processor 21, the bootcode 22a, the firmware code 12a, the backup code 12b of the firmware code 12a, the firmware code 13a, the restoration code 13b of the firmware code 13a, and the communication device 14. Further, the processor 21 (a) executes the bootcode 22a and determines whether the firmware code 12a is falsified or not, (b) if it is determined that the firmware code 12a is not falsified, executes the firmware code 12a and determines whether the firmware code 13a is falsified or not, (c) if it is determined that the firmware code 12a is falsified, restores the firmware code 12 with the backup code 12b, and (d) if it is determined that the firmware code 13a is falsified, executes the restoration code 13b and thereby accesses the external server 3 using the communication device 14, downloads a genuine firmware code from the external server 3, and restores the firmware code 13a with the downloaded genuine firmware code.

Consequently, when falsification of the firmware code 12a is detected, a genuine firmware code for the firmware code 13a is not downloaded and therefore, only a small memory capacity is required for the restoration when the falsification is detected.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, if the genuine firmware code can not be downloaded due to network failure or the like, the downloading may be retried after a predetermined time elapses, and when the genuine firmware code becomes able to be downloaded, the genuine firmware code may be downloaded and the restoration of the firmware code 13a may be performed.

Further, in the aforementioned embodiment, if the genuine firmware code can not be downloaded due to network failure or the like (if the electronic apparatus is in an off-line status or if the downloading can not be performed for a predetermined time or longer), a user may be notified of this situation. For example, a message that indicates this situation is displayed on this electronic apparatus 1.

Furthermore, in the aforementioned, the processor 21 may determine whether the downloaded genuine firmware code is falsified or not in accordance with the restoration code 13b; and if the downloaded genuine firmware code is not falsified, may perform the aforementioned restoration, and if the downloaded genuine firmware code is falsified, may not perform the aforementioned restoration and notify a user of this situation.

Furthermore, in the aforementioned, the processor 21 may perform authentication of the external server 3 in accordance with the restoration code 13b; and if the authentication is succeeded, download the genuine firmware code, and if the authentication is not succeeded, may not download the genuine firmware code and notify a user of this situation.

Furthermore, in the aforementioned, if the restoration is failed, a user may be notified of the failure.

Furthermore, in the aforementioned, the restoration is automatically performed, but the restoration may be started in accordance with a user operation.

Furthermore, in the aforementioned, the restoration code 13b is stored in the storage 13. Alternatively, the restoration code 13b may be stored in the flash memory 12.

What is claimed is:

1. An electronic apparatus, comprising:
a processor;
a bootcode;
a first firmware code;
a backup code of the first firmware code;
a second firmware code;
a restoration code of the second firmware code; and
a communication device;
wherein the processor (a) executes the bootcode and determines whether the first firmware code is falsified or not, (b) if it is determined that the first firmware code is not falsified, executes the first firmware code and determines whether the second firmware code is falsified or not, (c) if it is determined that the first firmware code is falsified, restores the first firmware code with the backup code, and (d) if it is determined that the second firmware code is falsified, executes the restoration code and thereby accesses an external server using the communication device, downloads a genuine firmware code from the external server, and restores the second firmware code with the downloaded genuine firmware code.

2. The electronic apparatus according to claim 1, wherein the bootcode is stored in a read only memory;
the first firmware code and the backup code are stored in a flash memory; and
the second firmware and the restoration code are stored in another storage than the flash memory.

3. The electronic apparatus according to claim 1, wherein the processor (a) restarts this electronic apparatus if the second firmware code is restored, (b) after the first firmware code is restored, if it is determined that the second firmware code is not falsified, does not restart this electronic apparatus but performs a starting process based on the second firmware code.
